(19) United States
(12) Patent Application Publication
(10) Pub. No.: US 2024/0034391 A1
(43) Pub. Date: Feb. 1, 2024

(54) ECCENTRIC BEARING RACK ANTI-ROTATION ASSEMBLY

(71) Applicant: Steering Solutions IP Holding Corporation, Saginaw, MI (US)

(72) Inventors: Christopher R. Case Myers, Frankenmuth, MI (US); John S. Beam, Freeland, MI (US)

(21) Appl. No.: 18/361,234

(22) Filed: Jul. 28, 2023

Related U.S. Application Data
(60) Provisional application No. 63/393,269, filed on Jul. 29, 2022.

(51) Int. Cl. B62D 5/00; F16H 19/04; F16H 57/12

(52) U.S. Cl. CPC B62D 5/001; F16H 19/04; F16H 57/12

(57) ABSTRACT

A steer-by-wire system for a vehicle includes a ball screw. The steer-by-wire system also includes a ball nut threadedly coupled to the ball screw, wherein rotation of the ball nut actuates translation of the ball screw. The steer-by-wire system further includes a bearing assembly. The bearing assembly includes an inner race. The bearing assembly also includes an outer race having an outer surface disposed within an axial groove defined within the ball screw to prevent rotation of the ball screw.

### CROSS-REFERENCE TO RELATED APPLICATION

This application claims the benefits of priority to U.S. Provisional Patent Application Ser. No. 63/393,269, filed Jul. 29, 2022, the disclosure of which is incorporated by reference herein in its entirety.

### BACKGROUND

Various electric power steering (EPS) systems have been developed for assisting an operator with vehicle steering. One type of EPS system is referred to as a rack electric power steering (REPS) system that utilizes an electric motor that drives a ball nut and rack. The rack teeth are engaged with a pinion which complements a driving feature that is rotated in response to rotation of a portion of the steering column by an operator, with the driving feature providing a steering input to the rack. The driving feature may be integrated with the steering column (i.e., single pinion electric power steering system) or may be a driving pinion (i.e., dual pinion electric power steering system), for example.

OEMs may be interested in removing the pinion for better packaging and cost during development of steer-by-wire gear systems. In a steer by wire system for a vehicle, an anti-rotation device is needed if a pinion is not used in the steering system to resist the rotation of the ball screw created by the loading of the ball nut thread.

### SUMMARY

According to one aspect of the disclosure, a steer-by-wire system for a vehicle includes a ball screw. The steer-by-wire system also includes a ball nut threadedly coupled to the ball screw, wherein rotation of the ball nut actuates translation of the ball screw. The steer-by-wire system further includes a bearing assembly. The bearing assembly includes an inner race. The bearing assembly also includes an outer race having an outer surface disposed within an axial groove defined within the ball screw to prevent rotation of the ball screw.

According to another aspect of the disclosure, an anti-rotation assembly includes a linear translating component moveable in an axial direction, the linear translating component defining an axial groove defined by a curved groove surface. The anti-rotation assembly also includes a bearing assembly in contact with the linear translating component to prevent rotation of the linear translating component. The bearing assembly includes an inner race. The bearing assembly also includes an outer race having an outer surface disposed within the axial groove defined within the linear translating component to prevent rotation of the linear translating component, wherein outer race has curvature in both an axial direction of the groove and in a circumferential direction of the groove.

These and other advantages and features will become more apparent from the following description taken in conjunction with the drawings.

### BRIEF DESCRIPTION OF THE DRAWINGS

The subject matter of the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic illustration of a power steering system;

FIG. 2 is a perspective view of a rack housing of the power steering system;

FIG. 3 is a perspective, cross-sectional view of the rack housing illustrating an anti-rotation assembly and a linear translating component;

FIG. 4 is a first perspective view of the anti-rotation assembly;

FIG. 5 is a second perspective view of the anti-rotation assembly; and

FIG. 6 is a schematic illustration of the anti-rotation assembly.

### DETAILED DESCRIPTION

Referring now to the Figures, where the present disclosure will be described with reference to specific embodiments, without limiting same, it is to be understood that the disclosed embodiments are merely illustrative of the present disclosure that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The embodiments described herein are used in conjunction with a steering assembly of a vehicle, such as a car, truck, sport utility vehicle, crossover, mini-van, marine craft, aircraft, all-terrain vehicle, recreational vehicle, or other suitable vehicles which include various steering system schemes. As discussed herein, an electric power steering (EPS) system, including a steer-by-wire system, for example, includes an anti-rotation device where a pinion is not used in the steering system. The anti-rotation device resists rotation of a linear translating component. Such rotation is induced by the loading of an actuating component in contact with the linear translating component, such as the threading of a ball nut, for example.

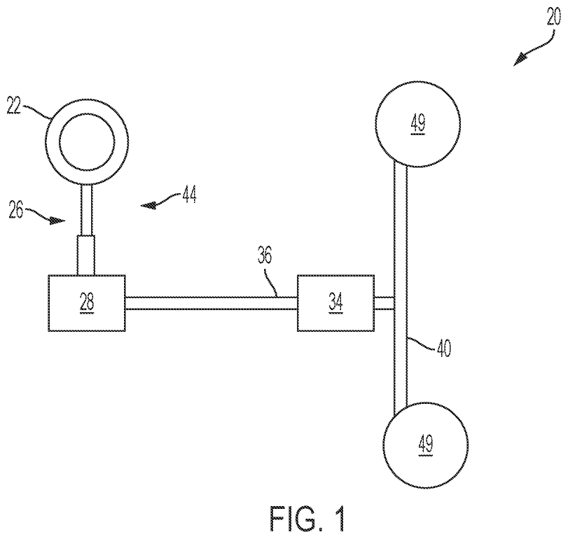

Referring initially to FIG. 1, a power steering system 20 is generally illustrated. The power steering system 20 may be configured as a driver interface steering system, an autonomous driving system, or a system that allows for both driver interface and autonomous steering. The steering system may include an input device 22, such as a steering wheel, wherein a driver may mechanically provide a steering input by turning the steering wheel. A steering column 26 extends along an axis from the input device 22 to an output assembly 28. The embodiments disclosed herein are utilized in steering systems where the output assembly 28 is in operative communication (e.g., steer-by-wire, autonomous system, etc.) with an actuator 34 that is coupled to a linear translating component 40. The output assembly 28 has wired electrical communication 36 with the actuator 34. Actuator 34 drives the linear translating component 40 to provide steering control of the vehicle.

The linear translating component 40 is any component having a generally cylindrical cross-section along at least a portion of the length thereof and is driven in a substantially linear manner to effectuate adjustment of vehicle road wheels 49. In some embodiments, the linear translating component 40 is a ball screw. In other embodiments, the linear translating component 40 is a lead screw. The preceding examples are not limiting of the linear translating component 40.

In prior steer-by-wire steering systems, a pinion is utilized on an outer surface of the linear translating component 40 (e.g., “rack”) to provide steering input control of the linear translating component 40. Such a pinion also provides anti-rotation reaction forces on the linear translating component 40 to counter forces applied by the actuator 34, such as a ball nut, for example. However, the pinion and associated required components (e.g., pinion upper and lower bearing, rack bearing, adjuster plug, lower rotor, and rack teeth, etc.) may be undesirable in certain steering systems based on packaging requirements, cost, and manufacturing complexity, for example. The embodiments of an anti-rotation device disclosed herein provide the anti-rotation benefits of the previously required pinion, while eliminating the numerous components noted above. The above-referenced steering input control of the linear translating component 40 with a pinion is unnecessary in a steer-by-wire steering system.

Although the embodiments disclosed herein are described in connection with an EPS system located at the lower/forward portion of a steering column and system, it is to be understood that EPS systems providing assistance at other column locations may benefit from the disclosed embodiments. In particular, a column EPS (CEPS) system may utilize the embodiments disclosed herein. Furthermore, the anti-rotation device disclosed herein may be used in any system that relies on a substantially cylindrical component driven in a translating manner and which requires or would benefit from limitation of rotation.

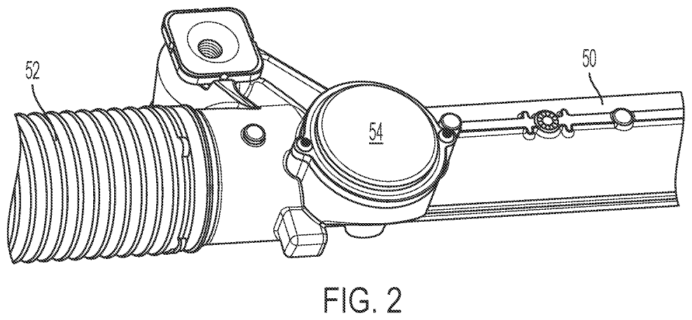

Referring to FIG. 2, a portion of a rack housing 50 is shown with a sealing component 52, such as a sealing boot, operatively coupled to an end of the rack housing 50. The rack housing 50 houses the linear translating component 40. The rack housing 50 includes a cover 54 which may be repeatedly removed to access interior regions of the rack housing 50.

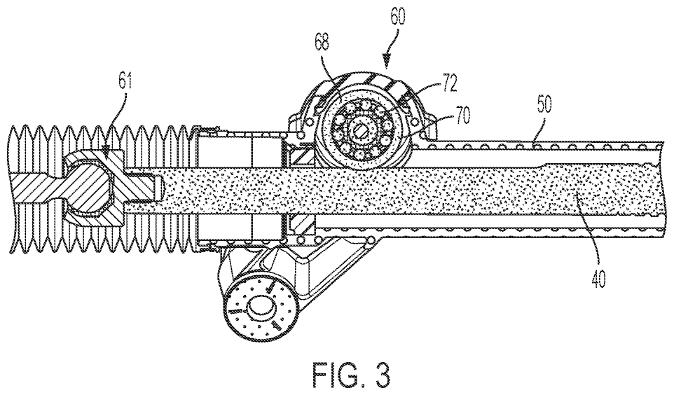

FIG. 3 is a cross-sectional view of the rack housing 50, the linear translating component 40 and an anti-rotation assembly 60, as well as associated components. As shown, the linear translating component 40 extends longitudinally about an axis A in what is referred to as an axial direction herein. An end of the linear translating component 40 is operatively coupled to one or more components 61 which connect the linear translating component 40 to road wheels of the vehicle. For example, tie rods and other components may be used in a conventional manner. This connection allows axial movement of the linear translating component 40 to adjust the road wheels in a manner required to carry out steering maneuvers.

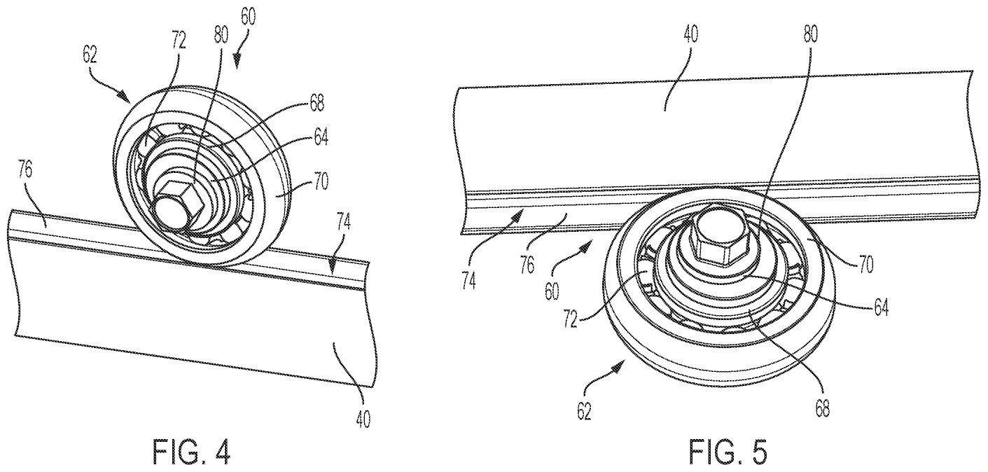

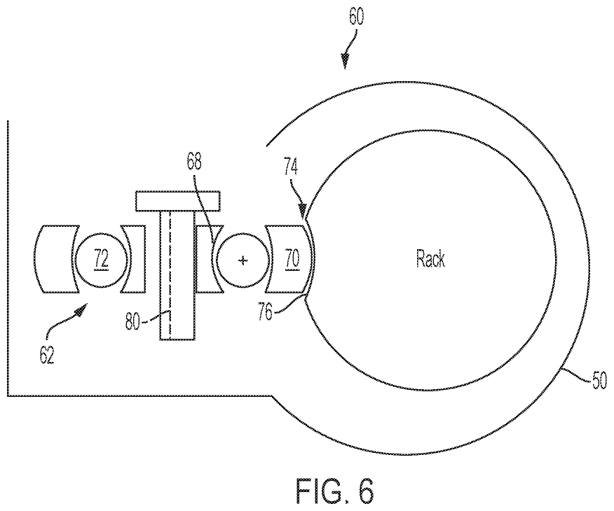

Referring now to FIGS. 4 and 5, with continued reference to FIG. 3, the anti-rotation assembly 60 is provided to counter forces applied by the actuating component 34, such as a ball nut, for example. The anti-rotation assembly 60 includes a bearing assembly 62 and a delash component 64. The anti-rotation assembly 60 is at least partially disposed within the rack housing 50, such as within a compartment covered by the cover 54 shown in FIG. 2. The bearing assembly 62 may be a standard bearing that is machined or otherwise modified to provide the features disclosed herein. Alternatively, the bearing assembly 62 may be a specifically manufactured bearing. Regardless of the process in which the bearing assembly 62 is made, the bearing assembly 62 includes an inner race 68, an outer race 70 and a plurality of balls 72 disposed between the inner race 68 and the outer race 70.

The outer race 70 is seated within a groove 74 defined in the linear translating component 40. The groove 74 extends longitudinally in the same direction as the longitudinal axis A of the linear translating component 40 to accommodate axial movement of the linear translating component 40 relative to the outer race 70 of the bearing assembly 62, while allowing the outer race 70 to remain within the groove 74.

The groove 74 is defined by a curved groove surface 76. The outer race 70 of the bearing assembly 62 is shaped to maximize contact with a radius of the curved groove surface 76. In other words, when installed within the groove 74, the outer race 70 has a curvature in both the axial direction of the groove 74 and in a circumferential direction of the groove 74. While the radius of curvature of each of the curved groove surface 76 and the outer race 70 is not identical in some embodiments, the curvature of each component is matched similarly to allow the bearing assembly 62 to prevent rotation of the linear translating component 40. In operation, as the linear translating component 40 (e.g., ball screw) is biased to rotate due to torque from the actuating component (e.g., ball nut), disposal of the curved outer race 70 within the groove 74 reacts on the curved groove surface 76 to prevent rotation of the linear translating component 40.

The inner race 68 is in contact with a component, such as an eccentric pin 80. The contact between the inner race 68 and the eccentric pin 80 delashes the interfaces of the bearing assembly 62 with surrounding structures. Alternatively, eccentric cam action may be achieved with the use of an eccentric outer race or inner race. Additionally, teeth are added to the non-functional area of the outer race 70 or on the inner race 68 in some embodiments to allow a position sensor to be added to the overall assembly. The position sensor may be a contacting or non-contacting position sensor, as those electrical options may be an alternative to the gear teeth on the outer/inner races.

The embodiments disclosed herein allow the overall system to be insensitive to long draft angle compensation in the housing and provides a simple structure to provide anti-rotation. Additional mechanisms like that illustrated and disclosed herein may be added to carry a higher anti-rotation load or to balance out the system if needed. The embodiments may be made insensitive to side loading if the bearing assembly is placed near a support in the system that handles the radial loading such as the outboard support bushing.

The embodiments disclosed herein allow for a reduction in packaging space required of EPS systems based on removal of several components, including a pinion, a pinion upper and lower bearing, a rack bearing, an adjuster plug, a lower rotor, and rack teeth in the case of a REPS system. Additionally, cost and complexity associated with manufacturing and assembly of the overall system is reduced with the anti-rotation assembly 60 disclosed herein. This is also coupled with a mating wear component. For example in one embodiment the mating wear component may be a bushing to meet NVH and friction requirements.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the scope of the present disclosure. Additionally, while various embodiments of the present disclosure have been described, it is to be understood that aspects of the present disclosure may include only some of the described embodiments or combinations of the various embodiments. Accordingly, the present disclosure is not to be seen as limited by the foregoing description.

The features disclosed herein utilize a modified bearing outer race to provide anti-rotation to a screw mechanism and the ability to delash that anti-rotation with an eccentric feature. Additionally, the use of a tooth form on this mechanization allows it to be used as an absolute position sensor for the screw translation.

What is claimed is:

1. A steer-by-wire system for a vehicle comprising:
a ball screw;
a ball nut threadedly coupled to the ball screw, wherein rotation of the ball nut actuates translation of the ball screw; and
a bearing assembly comprising:
an inner race; and
an outer race having an outer surface disposed within an axial groove defined within the ball screw to prevent rotation of the ball screw.

2. The steer-by-wire system of claim 1, wherein the axial groove of the ball screw is defined by a curved groove surface.

3. The steer-by-wire system of claim 2, wherein outer race has curvature in both an axial direction of the groove and in a circumferential direction of the groove.

4. The steer-by-wire system of claim 2, wherein the curvature of the outer race in the circumferential direction of the groove corresponds to the curvature of the curved groove surface.

5. The steer-by-wire system of claim 1, further comprising a rack housing at least partially containing the ball screw, wherein the bearing assembly is disposed within the rack housing.

6. The steer-by-wire system of claim 1, wherein the inner race is in contact with a component to delash the bearing assembly.

7. The steer-by-wire system of claim 6, wherein the component in contact with the inner race is an eccentric pin.

8. The steer-by-wire system of claim 7, wherein the eccentric pin is disposed within the rack housing and is accessible through a compartment cover coupled to the rack housing.

9. The steer-by-wire system of claim 1, wherein the bearing assembly is delashed with an eccentric cam arrangement, wherein the eccentric cam arrangement includes the inner race or the outer race being eccentric.

10. The steer-by-wire system of claim 1, further comprising at least one tooth disposed on the outer race to be detectable by a position sensor.

11. The steer-by-wire system of claim 1, further comprising at least one tooth disposed on the inner race to be detectable by a position sensor.

12. The steer-by-wire system of claim 1, further comprising a position sensor configured to detect the position of the bearing assembly.

13. An anti-rotation assembly comprising:
a linear translating component moveable in an axial direction, the linear translating component defining an axial groove defined by a curved groove surface; and
a bearing assembly in contact with the linear translating component to prevent rotation of the linear translating component, the bearing assembly comprising:
an inner race; and
an outer race having an outer surface disposed within the axial groove defined within the linear translating component to prevent rotation of the linear translating component, wherein outer race has curvature in both an axial direction of the groove and in a circumferential direction of the groove.

14. The anti-rotation assembly of claim 13, wherein the curvature of the outer race in the circumferential direction of the groove corresponds to the curvature of the curved groove surface.

15. The anti-rotation assembly of claim 13, further comprising a housing at least partially containing the linear translating component, wherein the bearing assembly is disposed within the housing.

16. The anti-rotation assembly of claim 13, wherein the inner race is in contact with a component to delash the bearing assembly.

17. The anti-rotation assembly of claim 16, wherein the component in contact with the inner race is an eccentric pin.

18. The anti-rotation assembly of claim 17, wherein the eccentric pin is disposed within the housing and is accessible through a compartment cover coupled to the housing.

19. The anti-rotation assembly of claim 13, further comprising at least one tooth disposed on the outer race to be detectable by a position sensor.

20. The anti-rotation assembly of claim 13, further comprising at least one tooth disposed on the inner race to be detectable by a position sensor.
